(19) United States
(12) Patent Application Publication
(10) Pub. No.: US 2005/0109415 A1
(43) Pub. Date: May 26, 2005

(54) Two piece air duct section

(76) Inventor: Darryl L. Snyder, Canton, OH (US)

Correspondence Address: Zollinger & Burleson, Ltd., P.O. Box 2368, North Canton, OH, 44720, US

(21) Appl. No.: 10/989,566

(22) Filed: Nov. 16, 2004

Related U.S. Application Data
(60) Provisional application No. 60/524,146, filed on Nov. 21, 2003.

(51) Int. Cl. F16L 9/00

(52) U.S. Cl. 138/162; 138/157

(57) ABSTRACT

An air duct section is formed from at least two longitudinal duct portions that snap together to form a hollow duct having a longitudinal direction. The duct section has a pair of ends that are adjustable between male and female configurations. The interlocking device used to connect the duct portions allows continuous adjustability between the first end and the second end of the duct section while minimizing air leaks and providing structural integrity to the duct section.

### CROSS REFERENCE TO RELATED APPLICATION

This application claims priority from U.S. Provisional Application Ser. No. 60/524,146 filed Nov. 21, 2003; the disclosure of which are incorporated by reference.

### BACKGROUND OF THE INVENTION

1. Technical Field

The present invention generally relates to conduits and ducts and, more particularly, the types of conduits and ducts that are formed from multiple longitudinal pieces. Specifically, the present invention relates to a two piece air duct that is formed from two longitudinal pieces that snap together in a manner that allows the ends of the section to be adjusted between male and female configurations.

2. Background Information

Air ducts in residential and commercial heating, ventilation, and air conditioning (HVAC) are typically formed from relatively thin sheet metal. The ducts may have round or rectangular cross sections and are typically purchased in formed sections of various lengths. Each section has a male end and a female end so that the duct sections may be fit together to form long lengths of duct. The ends may also be used to connect the duct sections to other duct components such as duct boots, duct elbows, diffusers, headers, and the like. Once two components are frictionally held together by inserting the male end into a female end, the joint may be secured with a fastener such as a sheet metal screw. Other installers simply use duct tape to hold the joints together.

As most HVAC installers know, installing sheet metal duct work is hazardous and frustrating when the installer must customize a standard-length duct section to fit a specific location on the job. The customization process typically involves cutting the sheet metal material which produces a sharp, and at times ragged, edge that can injure the fingers and hands of the installer. In addition to the sharp edges created by customizing a standard-length duct, the process of cutting a round or rectangular duct to length is somewhat difficult and time consuming. When a duct section is cut to length, one of the ends is removed leaving a new end that may not mate with the exposed end of the other component. In some situations, an adapter ring must be used to connect the two components after a duct section has been cut to length. Installers thus desire a duct that may be used in HVAC systems that may be easily and safely customized.

In addition to the installation problems, existing metal duct sections must be fabricated in the field from flat sheet metal or must be shipped in large shipping containers that necessarily contain a large volume of air. Although the large volume of air is not heavy, the containers are rather large. The large containers increase the cost of shipping sheet metal ducts from manufacturers to users. The industry thus desires a duct that is more compact for shipping.

### BRIEF SUMMARY OF THE INVENTION

The invention provides an air duct section that is formed from at least two longitudinal duct portions that snap together to form a hollow duct having a longitudinal direction. The duct section has a pair of ends that are adjustable between male and female configurations. The interlocking device used to connect the duct portions allows continuous adjustability between the first end and the second end of the duct section while minimizing air leaks and providing structural integrity to the duct section.

In one embodiment, the air duct includes first and second duct portions that each have a longitudinal direction. Each of the first and second duct portions has a first end and a second end. Each of the first and second duct portions has a male tooth and a female tooth with each of the teeth extending continuously in the longitudinal direction of the duct portions. The male tooth of the first duct portion engages the female tooth of the second duct portion and the female tooth of the first duct portion engaging the male tooth of the second duct portion to form a duct section.

### BRIEF DESCRIPTION OF THE SEVERAL VIEWS OF THE DRAWINGS

FIG. 1 is a perspective view of one of the duct portions used to form the two piece duct section of the present invention.

FIG. 2 is an end view of FIG. 1.

FIG. 3 is an enlarged view of one of the encircled portions of FIG. 2.

FIG. 4 is an enlarged view of the other of the encircled portions of FIG. 2.

FIG. 5 is an end view of the two piece duct section assembled from two of the duct portions shown in FIG. 1.

FIG. 6 is an enlarged view of the encircled portion of FIG. 5.

FIG. 7 is an elevation view showing three duct sections connected together and made in accordance with the present invention.

FIG. 8 is a section view taken along line 8-8 of FIG. 7.

FIG. 9 is an enlarged view of one of the encircled portions of FIG. 8.

FIG. 9A is an enlarged view of the other of the encircled portions of FIG. 8.

FIG. 10 is an elevation view showing one of the duct sections of the present invention used to connect a duct elbow and a duct boot.

FIG. 11 is a section view taken along line 11-11 of FIG. 10.

FIG. 12 is an enlarged view of the encircled portion of FIG. 11.

FIG. 13 is a section view taken along line 13-13 of FIG. 10.

FIG. 14 is an enlarged view of the encircled portion of FIG. 13.

FIG. 15 is an elevation view showing a duct section made in accordance with the concepts of the present invention used to connect a pair of duct elbows.

FIG. 16 is an elevation view showing the duct section of the present invention used to connect a pair of duct elements.

FIG. 17 is an end view of an alternative duct portion used to form the duct sections of the present invention.

FIG. 18 is an end view of a duct section formed with three duct portions.

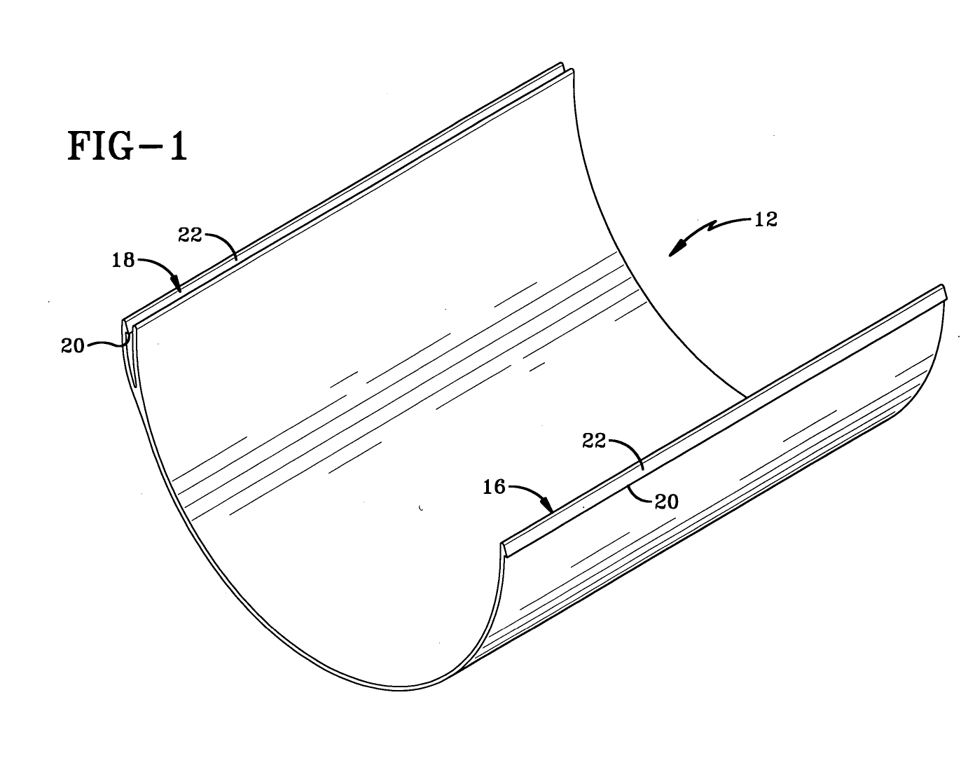

Similar numbers refer to similar parts throughout the specification.

### DETAILED DESCRIPTION OF THE INVENTION

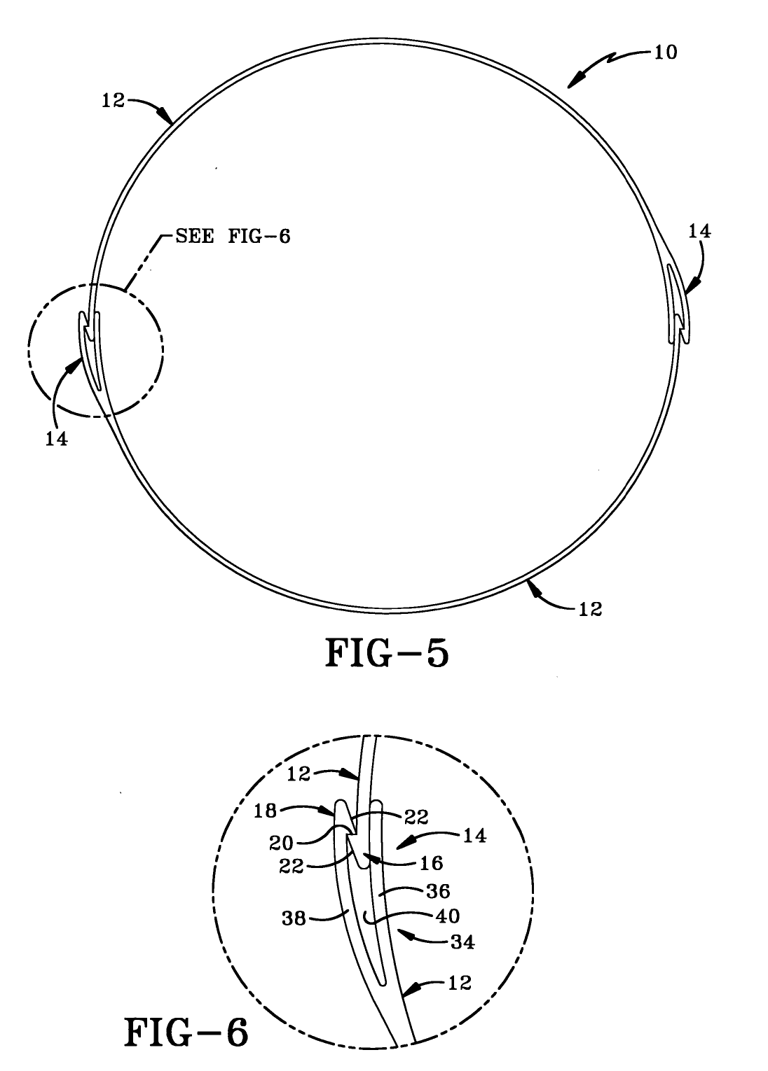

A duct section made in accordance with the concepts of the present invention is indicated generally by the numeral 10 in the accompanying drawings. Duct section 10 is formed by interlocking at least two duct portions 12 that interlock at two longitudinal joints 14 to form duct section 10. Each longitudinal joint includes a male tooth 16 and a female tooth 18 that lock together when portions 12 are connected to form duct section 10. Each tooth 16 and 18 defines a locking surface 20 and an angled surface 22 that allow teeth 16 and 18 to cooperate to fit together and then lock portions 12 in place. When only two portions 12 are used to form duct section 10, locking surfaces 20 are 180° apart from each other as depicted in FIG. 2 such that a 360° opening is formed when two duct portions 12 are connected together as shown in FIG. 5. When more than two duct portions 12 are used to form duct section 10 as shown in FIG. 18, the angle between locking surfaces 20 on a single duct portion 12 is less than 180°. For instance, when three duct portions 12 are used to form a duct section 10, locking surfaces 20 may be 120° apart.

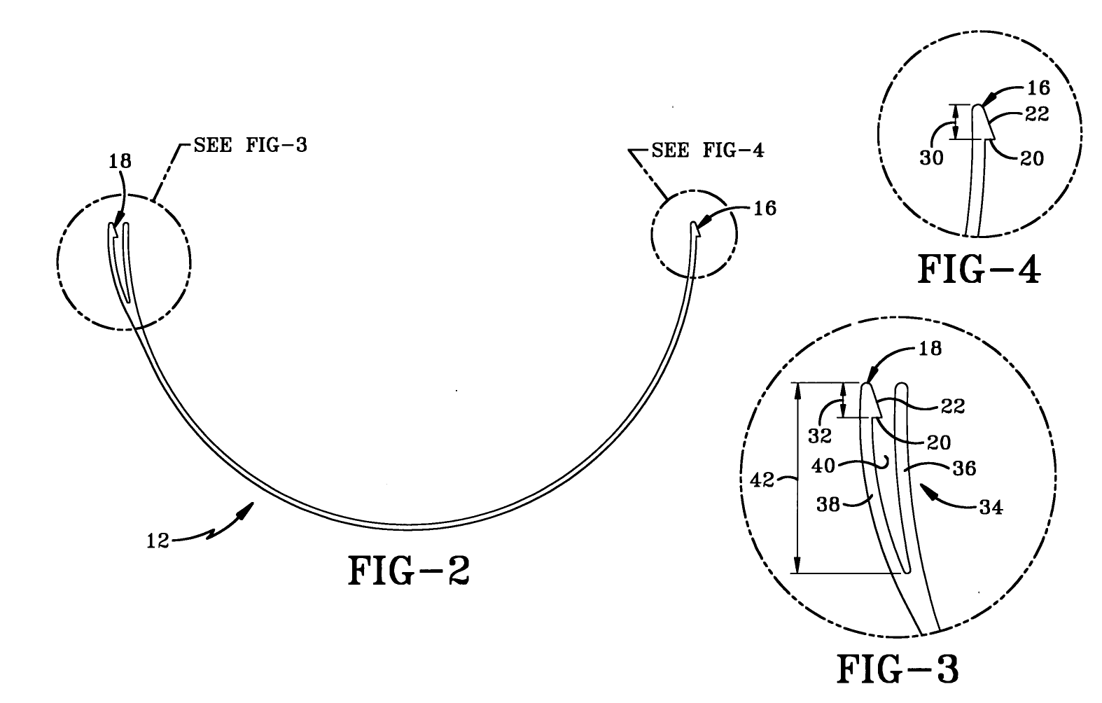

Male tooth 16 has a length indicated by dimension line 30 in FIG. 4. Female tooth 18 has a length indicated by the dimension line 32 in FIG. 3. Female tooth 18 is disposed at the end of a jaw 34 formed by an inner jaw portion 36 and an outer jaw portion 38. In the exemplary embodiment of the invention depicted in the drawings, female tooth 18 extends inwardly from outer jaw portion 38 while male tooth 16 extends outwardly. In other embodiments of the invention, female tooth 18 may extend outwardly from inner jaw portion 36. In such an alternative embodiment, male tooth 16 would project inwardly instead of outwardly as depicted in FIG. 4. Inner and outer jaw portions 36 and 38 define a locking channel 40 that receives male tooth 16 when longitudinal joints 14 are formed. As shown in FIG. 6, channel 40 has a width substantially equal to the thickness of male tooth 16 such that a tight fit is formed between teeth 16 and 18. Channel 40 has a length indicated by the dimension line 42 in FIG. 3 that allows male tooth 16 to slide between a female position (FIG. 6) and a male position (FIG. 9). The length of channel 40 may be four times the length of tooth 16 as shown in the drawings. When male tooth 16 is in the female position depicted in FIG. 6, the inside diameter of duct section 10 is large enough to receive a male end of another HVAC component. When male tooth 16 is in the male position depicted in FIG. 9, the outer diameter of duct section 10 is small enough to be received inside a female end of another HVAC component. Channel 40 is free of steps and locking devices between the male and female positions of male tooth 16 so that male tooth 16 may freely slide between the female and male positions along the length of duct section 10. Channel 40 thus allows a single duct section 10 to be configured with two male ends, two female ends, or one male end and one female end. When duct section 10 is configured with one male end and one female end, the position of male tooth 16 varies continuously with respect to channel 40 along the longitudinal length of duct section 10.

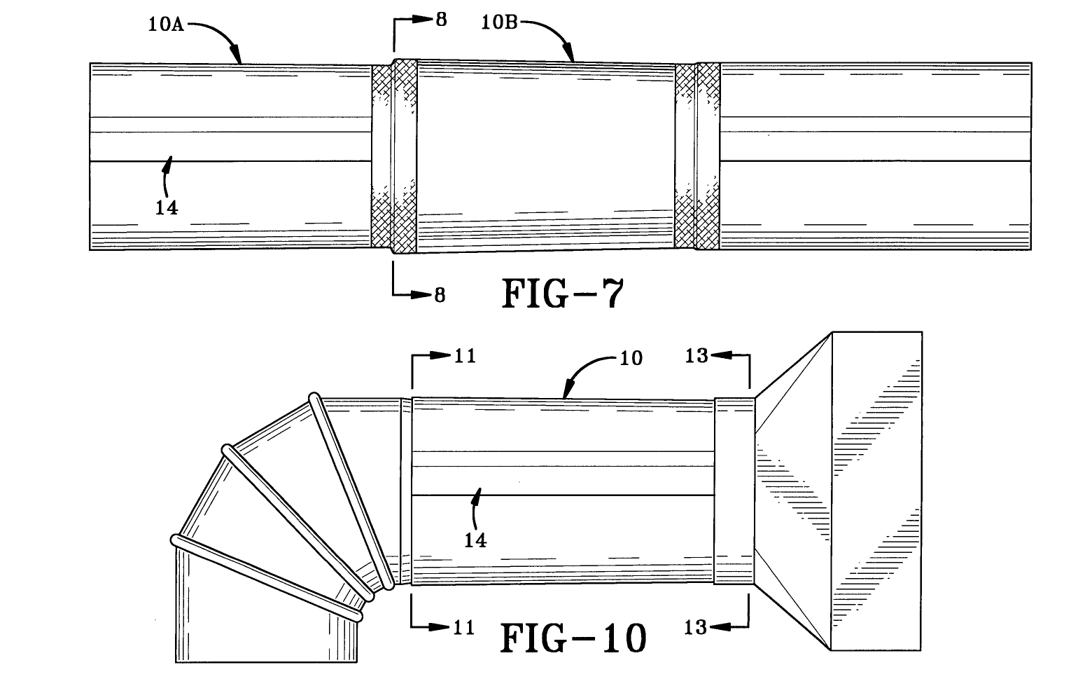

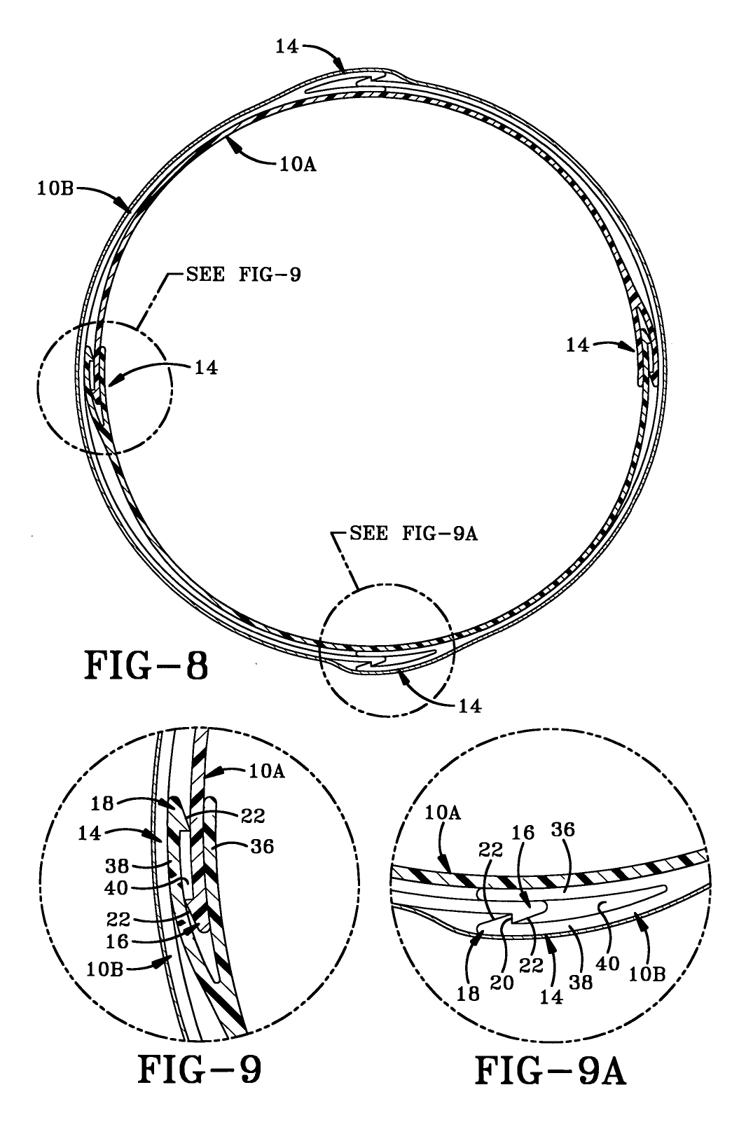

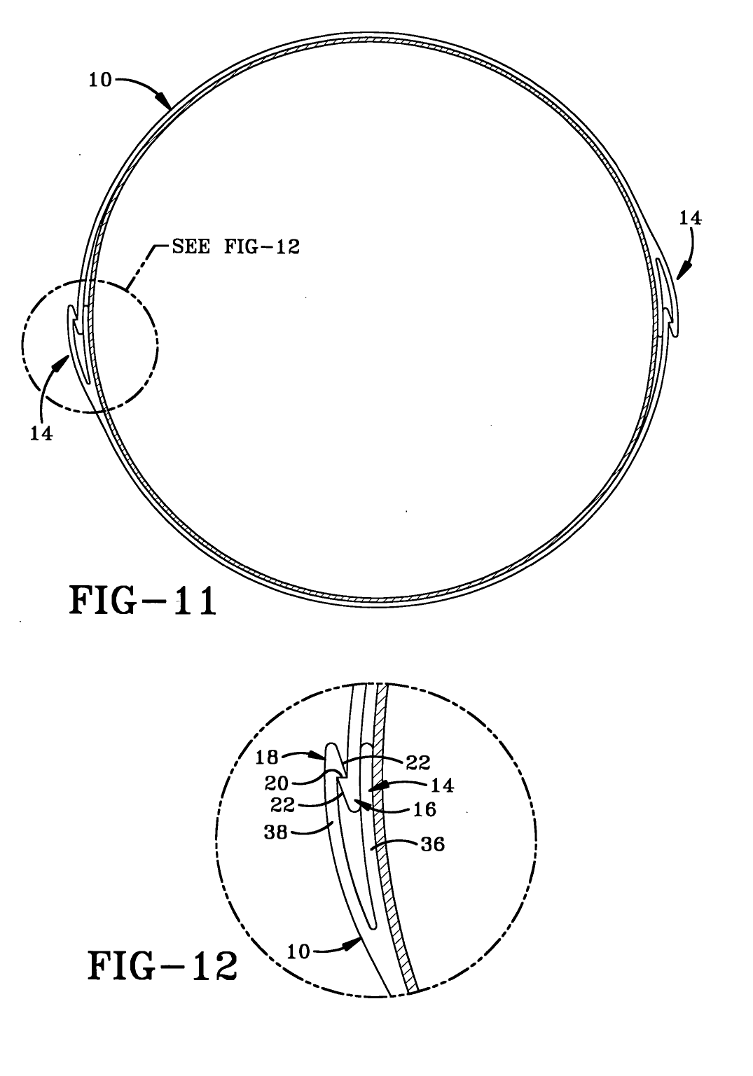

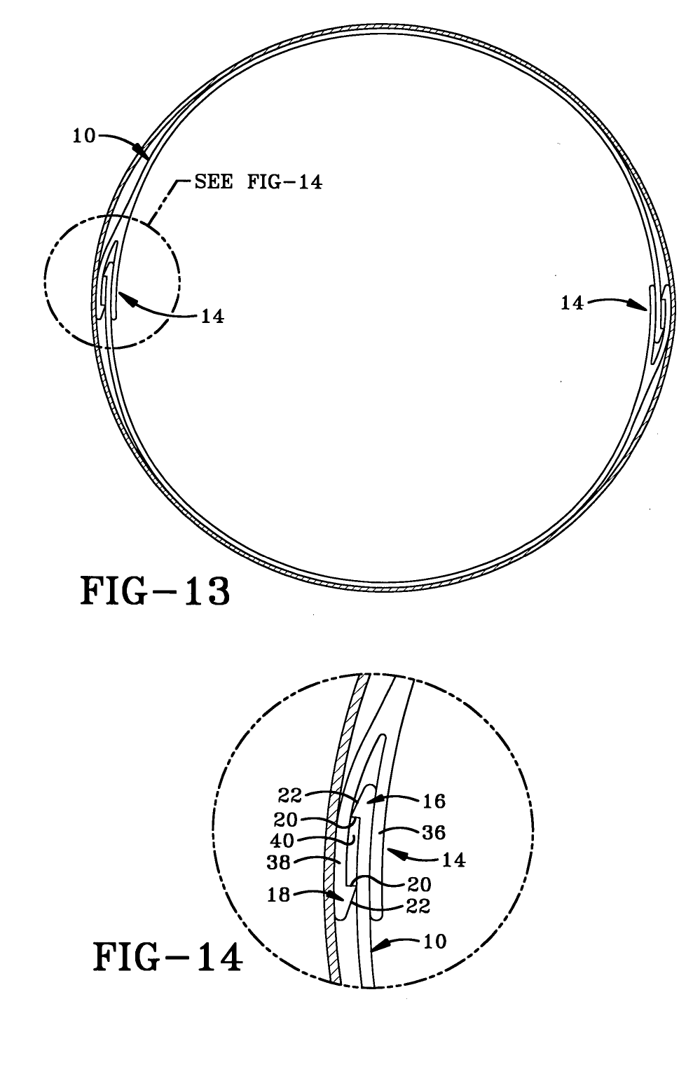

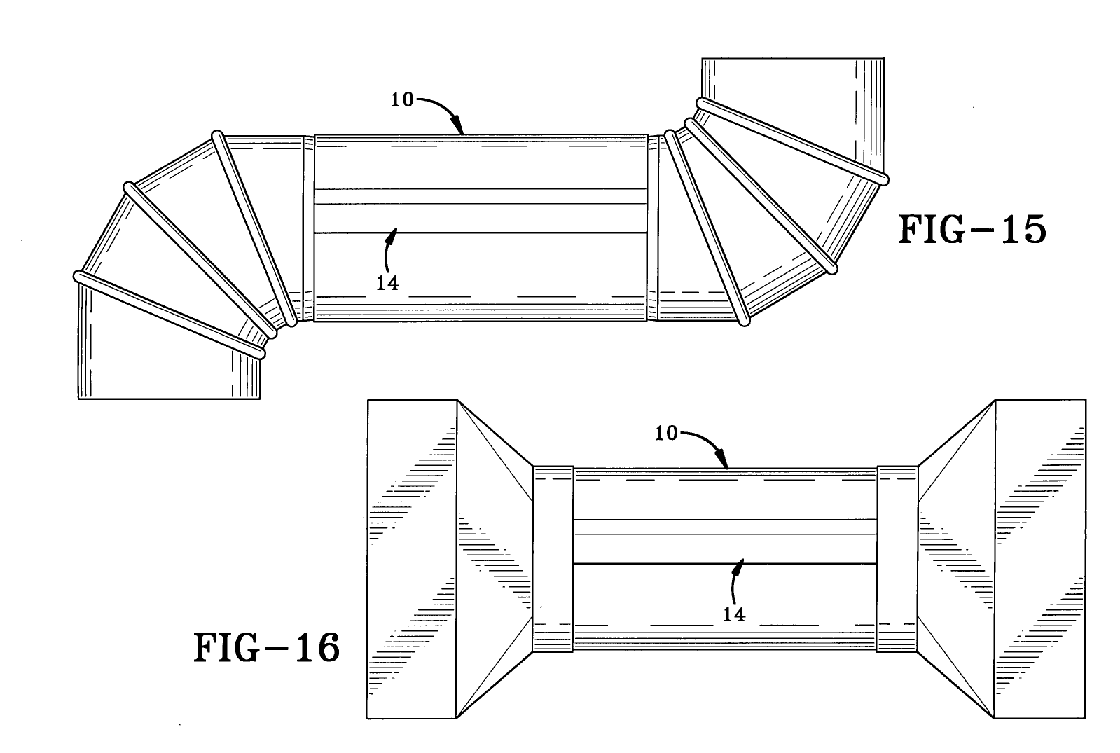

FIG. 5 shows one end of section 10 configured in the female configuration. FIGS. 7 and 8 show adjacent sections 10 with one end configured in a male configuration and slid into the female end of the other section 10 as shown in FIG. 8. FIGS. 9 and 9A show the different configurations for the teeth. FIGS. 10, 11, and 12 show an end of a section configured in a female orientation and receiving the end of a duct elbow. FIGS. 10, 13, and 14 show the other end of section 10 configured in a male configuration and received in the female end of a duct boot. FIG. 15 shows a duct section having two female ends used with two duct elbows. FIG. 16 shows a duct section with two male ends used with two other HVAC components.

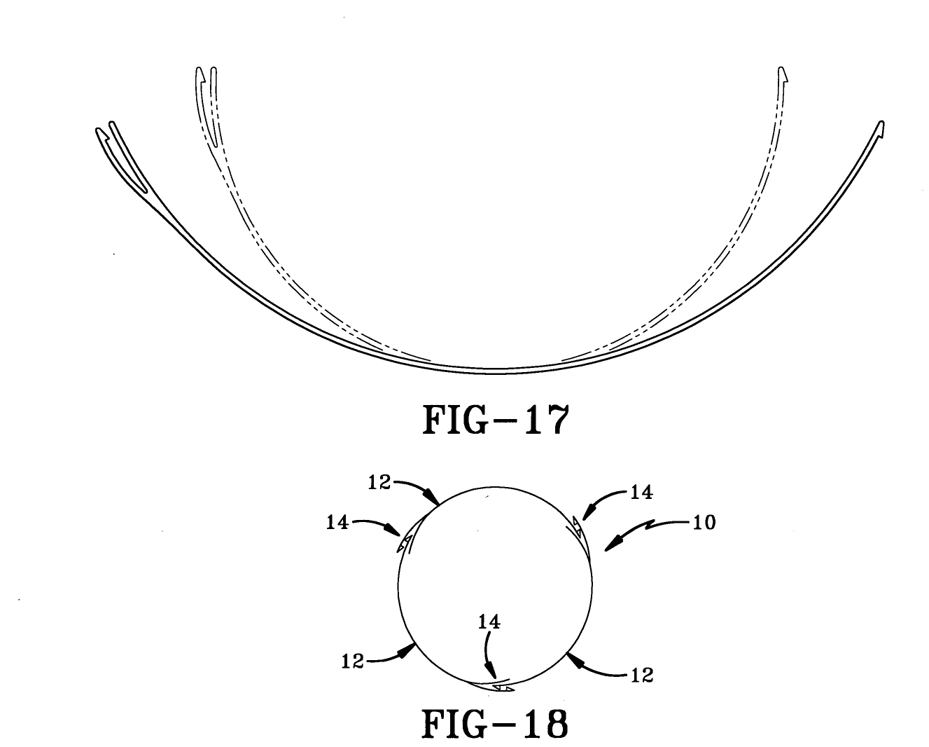

FIG. 17 depicts an alternative version of a duct portion. The alternative version is formed in a flattened configuration (depicted in solid lines in FIG. 17) such that the portion must be flexed to form a half circle as shown in the dashed in FIG. 17. This type of configuration builds a spring force into the duct sections that helps hold the duct portions together in a tight configuration.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An air duct section comprising:
first and second duct portions;
each of the duct portions having a longitudinal direction;
each of the first and second duct portions having a first end and a second end;
each of the first and second duct portions having a male tooth and a female tooth; each of the teeth extending continuously in the longitudinal direction of the duct portions between the first and second ends; and
the male tooth of the first duct portion engaging the female tooth of the second duct portion and the female tooth of the first duct portion engaging the male tooth of the second duct portion to form a duct section.

2. The air duct of claim 1, wherein each duct portion includes a jaw that defines a channel; the female tooth extending into the channel.

3. The air duct of claim 2, wherein the male tooth is disposed in the channel when the male tooth is engaged with the female tooth.

4. The air duct of claim 3, wherein the male tooth is movable between female and male positions within the channel such that the duct section may be configured to have either male or female ends.

5. The air duct of claim 4, wherein the channel is free of locking teeth that restrict the movement of the male tooth between the female and male positions.

6. The air duct section of claim 1, wherein each of the duct portions has an inherent biasing force tending to flatten the duct portions.

7. The air duct section of claim 1, wherein each female tooth extends inwardly and each male tooth extends outwardly.

8. The air duct section of claim 1, wherein the channel has a length and the male tooth has a length; the length of the channel being at four times the length of the male tooth.

9. An air duct section comprising:
first and second duct portions;
each of the duct portions having a longitudinal direction;
each of the first and second duct portions having a first end and a second end;
each of the first and second duct portions having a male tooth and a female tooth;
each of the first and second duct portions having a jaw that defines a channel; the female tooth extending into the channel;
the male tooth of the first duct portion engaging the female tooth of the second duct portion and the female tooth of the first duct portion engaging the male tooth of the second duct portion to form a duct section; and
the male tooth being movable between female and male positions within the channel such that the duct section may be configured to have either male or female ends.

10. The air duct section of claim 9, wherein the channel is free of locking teeth that restrict the movement of the male tooth between the female and male positions.

11. The air duct section of claim 10, wherein the jaw extends continuously between the first end and the second ends.

12. The air duct section of claim 11, wherein the female tooth extends continuously between the first end and the second ends.

13. The air duct section of claim 11, wherein the male tooth extends continuously between the first end and the second ends.

14. The air duct section of claim 9, wherein each of the duct portions has an inherent biasing force tending to flatten the duct portions.

15. The air duct section of claim 9, wherein each female tooth extends inwardly and each male tooth extends outwardly.

16. The air duct section of claim 9, wherein the channel has a length and the male tooth has a length; the length of the channel being at four times the length of the male tooth.

17. An air duct section comprising:
first and second duct portions;
each of the duct portions having a longitudinal direction;
each of the first and second duct portions having a first end and a second end;
each of the first and second duct portions having a male tooth and a female tooth;
each of the first and second duct portions having a jaw that defines a channel; the female tooth extending into the channel;
the channel extending continuously in the longitudinal direction of the duct portions between the first and section ends of the duct portion; and
the male tooth of the first duct portion engaging the female tooth of the second duct portion and the female tooth of the first duct portion engaging the male tooth of the second duct portion to form a duct section.

18. The air duct of claim 17 wherein the female tooth extends continuously between the first and second ends.

19. The air duct of claim 18, wherein the male tooth extends continuously between the first and second ends.
